(19) United States
(12) Patent Application Publication
(10) Pub. No.: US 2013/0246479 A1
(43) Pub. Date: Sep. 19, 2013

(54) COMPUTER-READABLE RECORDING MEDIUM, DATA MODEL CONVERSION METHOD, AND DATA MODEL CONVERSION APPARATUS

(71) Applicant: FUJITSU LIMITED, Kawasaki-shi (JP)

(72) Inventors: Tatsuo Kumano, Kawasaki (JP); Yasuo Noguchi, Kawasaki (JP); Munenori Maeda, Yokohama (JP); Masahisa Tamura, Kawasaki (JP); Ken Iizawa, Yokohama (JP); Toshihiro Ozawa, Yokohama (JP); Jun Kato, Kawasaki (JP)

(73) Assignee: Fujitsu Limited, Kawasaki-shi (JP)

(21) Appl. No.: 13/751,342

(22) Filed: Jan. 28, 2013

(30) Foreign Application Priority Data
Mar. 16, 2012 (JP) 2012-061193

(51) Int. Cl. G06F 17/30

(52) U.S. Cl. CPC G06F 17/30294
USPC 707/792

(57) ABSTRACT

A converting unit determines the type of data item of which data defined in a hierarchical data model is composed. When it is determined that the type of the data item is an array, the converting unit adds information obtained by binding array information, indicating an array, with order information, indicating the order of an array, to an item name of data that is defined in a non-hierarchical data model by using the item name and a value. When it is determined that the type of the data item is an object, the converting unit adds information obtained by binding object information, indicating an object, with an element to an item name. When it is determined that the type of the data item is a value, the converting unit creates data in the non-hierarchical data model by associating the value with the item name.

### CROSS-REFERENCE TO RELATED APPLICATION

This application is based upon and claims the benefit of priority of the prior Japanese Patent Application No. 2012-061193, filed on Mar. 16, 2012, the entire contents of which are incorporated herein by reference.

### FIELD

The embodiments discussed herein are directed to a computer-readable recording medium, a data model conversion method, and a data model conversion apparatus.

### BACKGROUND

In recent years, with the popularization of cloud computing, a new type of database called NoSQL has become widely used. The NoSQL database is not a relational database management system (RDBMS) and is, for example, a key value database or a document-oriented database.

A key value database has a data structure in which a value is allocated to a key or a data structure in which a column is allocated to a key. An example of a key value database includes HBase or Cassndra. HBase or Cassandra uses a data model in which the hierarchy is limited, for example, a single folder can be created in a route.

A document-oriented database has a schema-less data structure. An example of a document-oriented database includes a Mongo DB or a Couch DB. These databases use a data model in which complicated data that is used on the application side is stored without being processed. Because these document-oriented databases handle complicated data, when data is distributed to lots of database servers, the management of data and of consistency becomes complicated. In recent systems, because distributed processing is often performed on large scale data, key value databases have been used that uses a data model in which the hierarchy is limited.
Patent Document 1: Japanese National Publication of International Patent Application No. 2010-519625
Patent Document 2: Japanese Laid-open Patent Publication No. 2011-008451
Patent Document 3: Japanese Laid-open Patent Publication No. 2010-224824

However, with the conventional technology, there is a problem in that the efficiency with which an application is developed low.

For example, when developing an application by using a data model in which the hierarchy is limited, the following two methods are used: a first method, in which each element in the deepest hierarchy is used as an independent element, and a second method, in which a hierarchical element that is not used on the database side is used as a single element.

When the first method is used, an application developer examines the key conversion system. Specifically, because the data structure used on the application side is different from that used on the database side, it is needed to manage a key that associates the data on the application side with the data on the database side. Accordingly, when developing multiple applications having different hierarchies, a conversion system for a key is determined for each application, thus increasing the number of man-hours needed for its development.

Furthermore, when the second method is used, a search process performed on an application is a process for searching a group of multiple elements for a target element. Accordingly, the search process executed by the application becomes complicated, thus increasing the number of man-hours needed for its development.

### SUMMARY

According to an aspect of the embodiment, a computer-readable recording medium having stored therein a program causing a computer to execute a data model conversion process includes: determining the type of a data item of which data that is defined in a first data model is composed; adding, when it is determined at the determining that the type of the data item is an array, information obtained by binding array information indicating an array with order information indicating the order of an array to an item name of data that is defined in a second data model by using the item name and a value; adding, to the item name when it is determined at the determining that the type of the data item is an object, information obtained by binding object information indicating an object with an element; and creating, when it is determined at the determining that the type of the data item is a value, data that is defined in the second data model by associating the value with the item name.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of the overall configuration of a system according to a first embodiment;

FIG. 2 is a functional block diagram illustrating the configuration of an application server according to the first embodiment;

FIG. 3 is a flowchart illustrating the flow of an encoding process;

FIG. 4 is a flowchart illustrating the flow of a decoding process;

FIG. 5 is a schematic diagram illustrating an example configuration of data to be processed on the application server side;

FIG. 6 is a schematic diagram illustrating an example configuration of data stored in a database;

FIG. 7 is a schematic diagram illustrating an example configuration of data obtained by adding data to the main body of the data illustrated in FIG. 5;

FIG. 8 is a schematic diagram illustrating an example configuration of data that is stored in a database after the main body is added;

FIG. 9 is a schematic diagram illustrating an example configuration of data obtained by adding a comment to the data illustrated in FIG. 7;

FIG. 10 is a schematic diagram illustrating an example configuration of data stored in a database after a comment is added; and

FIG. 11 is a schematic diagram illustrating an example of the hardware configuration.

### DESCRIPTION OF EMBODIMENTS

Preferred embodiments will be explained with reference to accompanying drawings. The present invention is not limited to these embodiments.

### [a] First Embodiment

### Overall Configuration

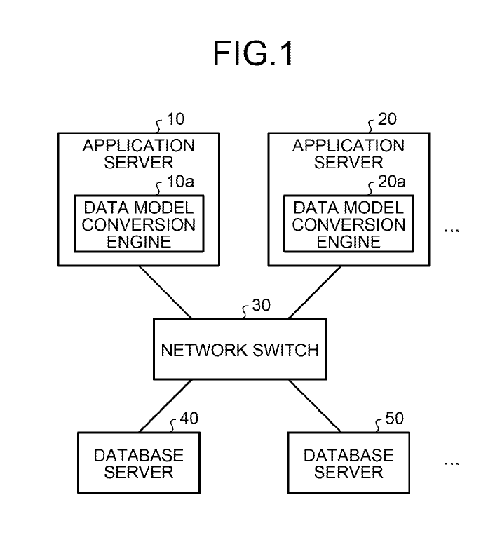

FIG. 1 is a schematic diagram illustrating an example of the overall configuration of a system according to a first embodiment. As illustrated in FIG. 1, the system includes an application server 10, an application server 20, a database server 40, a database server 50, which are connected to each other via a network switch 30. The number of servers and network switches illustrated in FIG. 1 is only an example and is not limited thereto.

Each of the application server 10 and the application server 20 is an application server that writes data to the database server 40 or the database server 50 and reads data from the database server 40 or the database server 50 by executing an application. In the embodiment, each of the applications executed by the application server 10 and the application server 20 performs a process on a data model (hereinafter, referred to as a hierarchical data model) in which the hierarchy is not limited.

Each of the database server 40 and the database server 50 is a database that stores therein data used by the application server 10 or the application server 20. In the embodiment, each of the database servers stores therein data by using a data model (hereinafter, referred to as a non-hierarchical data model) in which the hierarchy is limited, such as a key-value store (KVS).

The network switch 30 is a relay device that relays the communication between each device and is, for example, a layer 2 switch, a layer 3 switch, a router, or a gateway.

In this situation, by using a data model conversion engine, each application server automatically converts a data model 10a or 20a used in an application and stores the data model in each database server.

In the following, a description will be given, as an example, using a data model conversion engine 10a included in the application server 10. The data model conversion engine 10a identifies the type of data item defined by the hierarchical data model used by the application server. Then, if the data model conversion engine 10a identifies that the type of data item is an array, the data model conversion engine 10a creates an item name that is defined by the non-hierarchical data model used in the database server 40 from both information indicating the array and information indicating the order of the array. Furthermore, if the data model conversion engine 10a identifies that the type of data item is an object, the data model conversion engine 10a creates an item name from both information indicating the object and the data. Furthermore, if the data model conversion engine 10a identifies that the type of data item is a value, the data model conversion engine 10a creates data that is defined in the non-hierarchical data model by associating the value with the created item name.

In this way, when the data model conversion engine 10a stores data, which is defined in a hierarchical structure, in a database that does not have a hierarchical structure, such as a KVS, the data model conversion engine 10a can convert data by changing the conversion rules in accordance with the type of data, i.e., an array, an object, or a value. Consequently, the data model conversion engine 10a can automatically convert a data model, thus improving the efficiency with which an application is developed.

### Configuration of the Application Server

In the following, the application server illustrated in FIG. 1 will be described. The application server 10 and the application server 20 illustrated in FIG. 1 have the same configuration; therefore, a description will be given by using the application server 10 as an example. Furthermore, each of the database servers illustrated in FIG. 1 has the same configuration as a typical database server; therefore, a description in detail will be omitted.

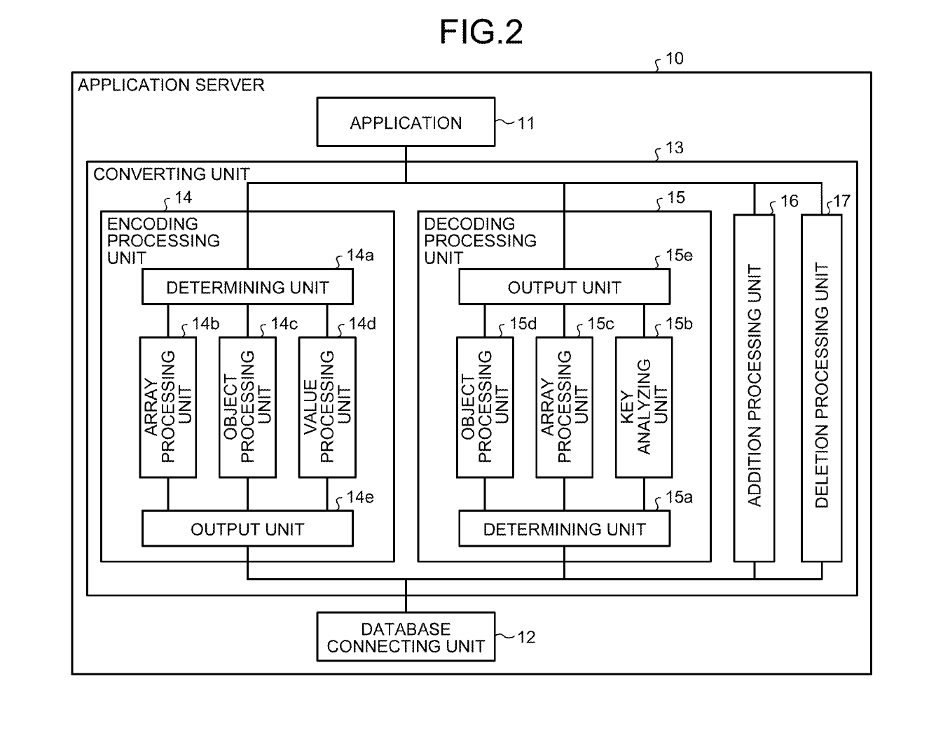

FIG. 2 is a functional block diagram illustrating the configuration of an application server according to the first embodiment. As illustrated in FIG. 2, the application server 10 includes an application 11, a database connecting unit 12, and a converting unit 13. Each of the processing units is a processing unit executed by, for example, a central processing unit (CPU). The converting unit 13 corresponds to the data model conversion engine 10a illustrated in FIG. 1.

The application 11 executes various processes stores data in the database server 40 by executing various processes to store. Furthermore, the application 11 read the data from the database server 40 by executing various processes.

The database connecting unit 12 is a processing unit that controls communication between each of the database servers and the application server 10. For example, the database connecting unit 12 outputs, to the database server 40, the data received from the converting unit 13 and an instruction to store the data. Furthermore, the database connecting unit 12 outputs, to the converting unit 13, the data received from the database server 40.

The converting unit 13 is a processing unit that includes an encoding processing unit 14, a decoding processing unit 15, an addition processing unit 16, and a deletion processing unit 17 and that converts a data model by using these processing units. Specifically, when storing, in a database server, the data that is defined in a hierarchical data model used by an application, the converting unit 13 automatically converts the data to data conforming to the non-hierarchical data model that is used by the database server. Furthermore, when outputting the data that is defined in a non-hierarchical data model used by the database server, the converting unit 13 automatically converts the data to data conforming to the hierarchical data model that is used by an application.

The encoding processing unit 14 is a processing unit that includes a determining unit 14a, an array processing unit 14b, an object processing unit 14c, a value processing unit 14d, and an output unit 14e and that converts data from the hierarchical data model to the non-hierarchical data model. Furthermore, as an initialization process when a data conversion process is performed, the encoding processing unit 14 determines that the prefix, i.e. the key, in a data model used by an application is “ ”.

The determining unit 14a is a processing unit that identifies the type of data item defined in a data model that is used by an application. Specifically, the determining unit 14a identifies whether the data item is an array or an object. If the determining unit 14a identifies that the data item is an array, the determining unit 14a outputs the data item to the array processing unit 14b. Furthermore, if the determining unit 14a identifies that the data item is an object, the determining unit 14a outputs the data item to the object processing unit 14c. Furthermore, if the determining unit 14a identifies that the data item is a value, the determining unit 14a outputs the data item to the value processing unit 14d.

The array processing unit 14b is a processing unit that converts the data item identified as an array to a form that can be represented in the non-hierarchical data model. Specifically, the array processing unit 14b executes data conversion in accordance with the conversion rule conforming to the array. Then, the array processing unit 14b outputs the data item of the converted data to the output unit 14e.

For example, for the data item that is input from the determining unit 14a, the array processing unit 14b creates an item name that is defined in the non-hierarchical data model from both information indicating an array and information indicating the order of the array. For example, if the data item is “[”, which indicates an array, the array processing unit 14b converts “[” to “_{—}0” by using both “_”, which indicates the array, and the sequence number “0”, which is allocated to the array. At this point, if “[” is at the top in the conversion-source database, the array processing unit 14b creates an item name, i.e., “_{—}0”, that is subsequent to “ ”.

The object processing unit 14c is a processing unit that converts a data item identified as an object to a form that can be represented in the non-hierarchical data model. Specifically, the object processing unit 14c executes data conversion in accordance with the conversion rule conforming to an object. Then, the object processing unit 14c outputs the data item of the converted data to the output unit 14e.

For example, for the data item that is input from the determining unit 14a, the object processing unit 14c creates an item name that is defined in the non-hierarchical data model from both the information indicating an object and the data item itself. For example, if the data is an object “id”, the object processing unit 14c converts “id” to “.id” by using both “.”, indicating the object, and “id”, indicating the data itself. Specifically, the object processing unit 14c creates a single item name by binding the data defined by the hierarchical that is not represented on the database side with “.”. At this point, if “d” is at the top in a conversion-source database, the object processing unit 14c adds an item name to “ ” and creates “.id”.

The value processing unit 14d is a processing unit that converts a data item identified as a value to a form represented in the non-hierarchical data model. Specifically, the value processing unit 14d executes data conversion in accordance with the conversion rule conforming to the value. Then, the value processing unit 14d outputs the data item of the converted data to the output unit 14e. For example, for a data item that is input from the determining unit 14a, the value processing unit 14d creates data that is defined in the non-hierarchical data model by associating the value with the item name.

In the following, a description will be given of a case in which the data is “:0” and the data item that is created until “:0” is input to the value processing unit 14d is “_{—}0.id”. In such a case, the value processing unit 14d associates “:0” with “_{—}0.id”. Specifically, the value processing unit 14d creates ““_{—}0.id”:0”. The data created at this point shows the relationship between a key and a Value. In a case of this example, ““_{—}0.id”” is the key and “:0” is the Value. Specifically, the value processing unit 14d creates data in which the item, which is created by the array processing unit 14b or the object processing unit 14c until the value processing unit 14d receives the item, is the key and the data, which is input to the value processing unit 14d, is the Value.

The output unit 14e is a processing unit that outputs the data created by each of the array processing unit 14b, the object processing unit 14c, and the value processing unit 14d to the database server 40 via the database connecting unit 12. For example, the output unit 14e outputs “_{—}0” received from the array processing unit 14b to the database server 40 via the database connecting unit 12.

The decoding processing unit 15 is a processing unit that includes a determining unit 15a, a key analyzing unit 15b, an array processing unit 15c, an object processing unit 15d, and an output unit 15e and that converts data from the non-hierarchical data model to the hierarchical data model.

The determining unit 15a is a processing unit that identifies the type of data that is defined in a data model used in a database server. Specifically, the determining unit 15a reads a single element from a database server. Then, the determining unit 15a outputs the read element to the key analyzing unit 15b. Then, the determining unit 15a identifies the data received from the key analyzing unit 15b as either an array or an object. Then, the determining unit 15a outputs the data identified as an array to the array processing unit 15c. Furthermore, the determining unit 15a outputs the data identified as an object to the object processing unit 15d.

For example, the determining unit 15a reads ““_{—}0.id”:0” as an element from a database server. Then, the determining unit 15a outputs the element ““_{—}0.id”:0” to the key analyzing unit 15b. Thereafter, the determining unit 15a receives, from the key analyzing unit 15b, ““0.id”:0”, from which “ ” is excluded. Then, then the determining unit 15a sequentially identifies each of “_{—}0”, “.id”, and “:0” as an array or an object.

In this case, first, the determining unit 15a identifies “_{—}0” as a 0^{th} array, i.e., a 1^{st} array, and outputs it to the array processing unit 15c. Then, the determining unit 15a identifies “.id” as an object that becomes an element of a first array and outputs it to the object processing unit 15d. Lastly, the determining unit 15a identifies that “:0” is a value of the first array and outputs it to the object processing unit 15d.

The key analyzing unit 15b is a processing unit that deletes a key from an element that is input from the determining unit 15a. Specifically, the key analyzing unit 15b deletes a key that is defined by the encoding processing unit 14 from an element that is input from the determining unit 15a. Then, the key analyzing unit 15b outputs, to the determining unit 15a, the data that is obtained by deleting a null character (key) from the element.

The array processing unit 15c is a processing unit that converts the data, which is managed as an array in the non-hierarchical data model in a database server, to an array that is used as the hierarchical data model by an application. Specifically, the array processing unit 15c creates an array from the data that is input from the determining unit 15a. For example, if “_{—}0” is input from the determining unit 15a, the array processing unit 15c creates a 0^{th} array, i.e., a 1^{st} array, in the hierarchical data model that is used by an application. Then, the array processing unit 15c outputs the created array to the output unit 15e.

The object processing unit 15d is a processing unit that converts the data, which is managed as an object in the non-hierarchical data model in a database server, to an object that is used as the hierarchical data model by an application. Specifically, the object processing unit 15d creates an object from the data that is input from the determining unit 15a.

For example, if “.id” that is subsequent to “_{—}0” is input from the determining unit 15a, the object processing unit 15d creates an object “id”, which is the first array, in the hierarchical data model used by an application. Then, the object processing unit 15d outputs the created object to the output unit 15e. Furthermore, if “:0” that is subsequent to “.id” that is subsequent to “_{—}0” is input from the determining unit 15a, the object processing unit 15d creates a value “0” of the object “id” in the first array in the hierarchical data model used by an application. Then, the object processing unit 15d outputs the created object to the output unit 15e.

The addition processing unit 16 is a processing unit that adds data to the database stored in the database server 40. Specifically, the addition processing unit 16 adds data to the database in which a data model is converted by the encoding processing unit 14. For example, if data to be added is a new array, the addition processing unit 16 adds an item name to the end of the database by using a new number that is obtained by incrementing the number specifying the array stored in the end of the database. Then, the addition processing unit 16 adds an object to the added item name, associates it with a value, and adds, to the database, the data to be added.

Furthermore, if the data to be added is a new element in the existing array, the addition processing unit 16 specifies both the array number and the number that is allocated to the element at the end of the array. Then, the addition processing unit 16 adds, to the end of the existing array in the database, an item name obtained by joining both the specified array number and the number obtained by incrementing the subject element number. Then, the addition processing unit 16 adds an object to the added item name, associates it with a value, and adds, to the database, the target data to be added.

The deletion processing unit 17 is a processing unit that deletes data from the database that is stored in the database server 40. Specifically, the deletion processing unit 17 deletes data from a database in which a data model is converted by the encoding processing unit 14. For example, if the data to be deleted is an array, the deletion processing unit 17 specifies, from the database, an item name that is constituted from the combination of the information that specifies the array and the order of the array. Then, the deletion processing unit 17 deletes the data associated with the specified item name from the database.

Flow of a Process

In the following, an encoding process and a decoding process executed by the application server 10 will be described.

Encoding Process

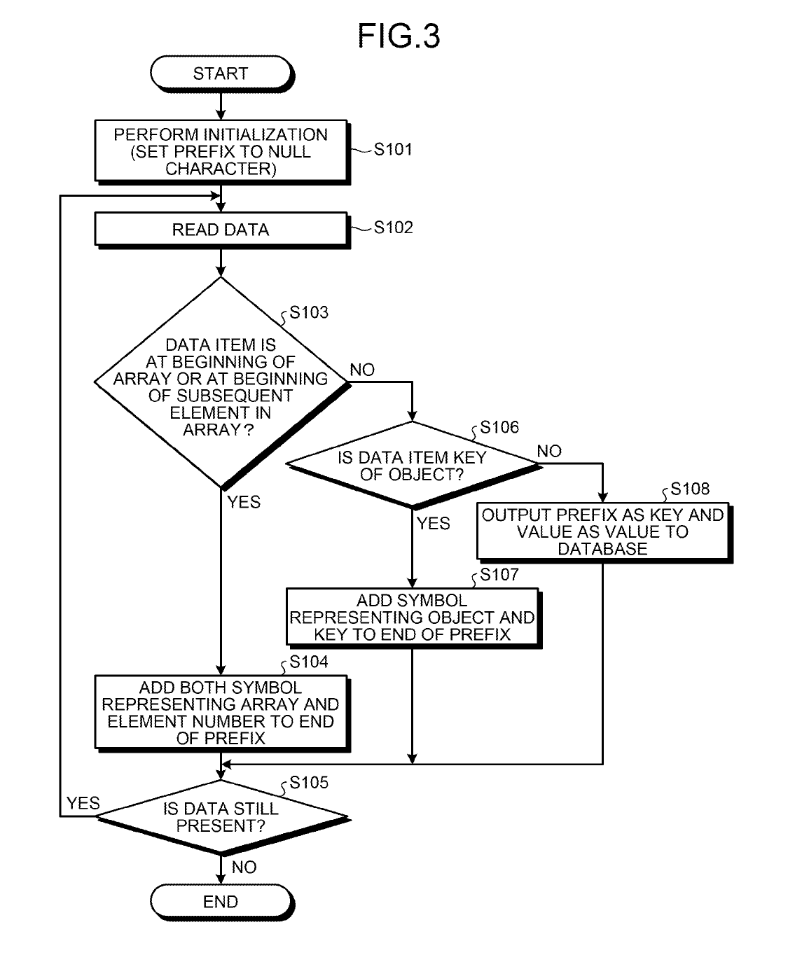

FIG. 3 is a flowchart illustrating the flow of an encoding process. As illustrated in FIG. 3, when the encoding processing unit 14 starts an encoding process, the encoding processing unit 14 determines that a prefix is a null character, which is performed as an initialization process (Step S101).

Subsequently, the determining unit 14a reads a data item from the database to be encoded (Step S102) and determines whether the data item is at the beginning of the array or at the beginning of the subsequent element in the array (Step S103).

If the determining unit 14a determines that the data item is at the beginning of the array or at the beginning of the next element in the array (Yes at Step S103), the array processing unit 14b adds both the symbol representing the array and the element number to the end of the prefix (Step S104). For example, the array processing unit 14b creates, for example, “_{—}0” as “prefix+symbol+number”.

Then, if the encoding processing unit 14 determines that a data item that has not been converted is present in a database to be encoded (Yes at Step S105), the encoding processing unit 14 repeats the process at Step S102 and the subsequent processes. In contrast, if the encoding processing unit 14 determines that a data item that has not been converted is not present in a database to be encoded (No at Step S105), the encoding processing unit 14 ends the encoding process.

Furthermore, at Step S103, if the determining unit 14a determines that the data is not at the beginning of the array nor at the beginning of the next element in the array (No at Step S103), the determining unit 14a determines whether the data item is the key of an object (Step S106).

If the determining unit 14a determines that the data item is the key of an object (Yes Step S106), the object processing unit 14c adds both the symbol representing the object and the key to the end of the prefix (Step S107). Then, the encoding processing unit 14 executes the process at 5105. For example, the object processing unit 14c creates “prefix+symbol+key”.

In contrast, if the determining unit 14a determines that the data item is not the key of an object, i.e., the determining unit 14a determines that the data item is a value (No Step S106) and outputs, to a database server, the data in which the prefix is a key and the value is a value (Step S108). After the processes at Step S108 is executed, the process at 5105 is executed.

Decoding Process

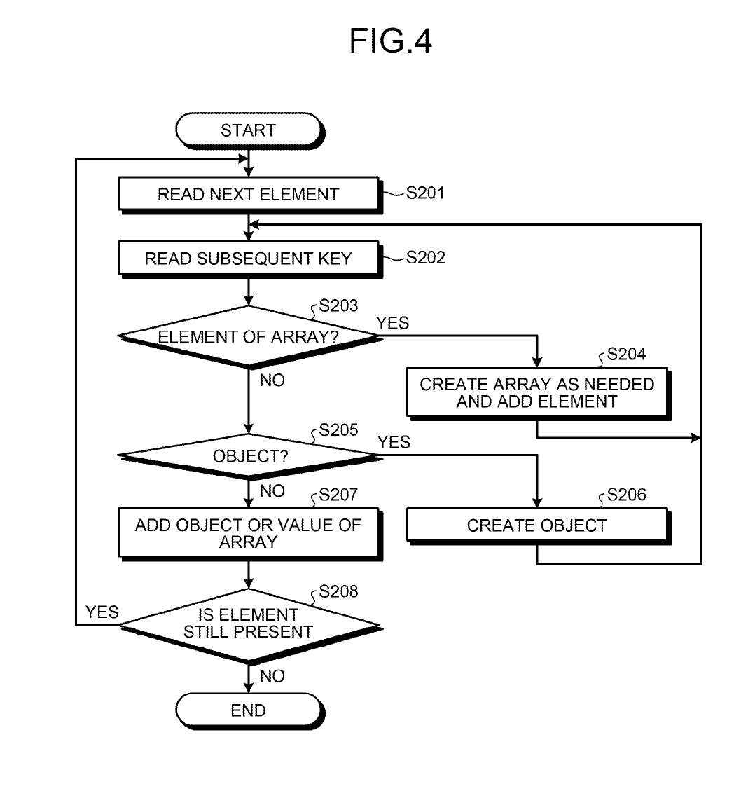

FIG. 4 is a flowchart illustrating the flow of a decoding process. As illustrated in FIG. 4, when starting the decoding process, the decoding processing unit 15 reads the next element (Step S201). When the process is started, the decoding processing unit 15 reads the top data that is the data to be decoded. For example, the determining unit 15a in the decoding processing unit 15 reads a single record, such as ““_{—}0.id”:0”.

Subsequently, the key analyzing unit 15b deletes, from the element ““_{—}0.id”:0” read by the determining unit 15a, “ ” that is handled by the encoding processing unit 14 as a key and reads the data subsequent to the key (Step S202).

Then, if the determining unit 15a determines that the read data is an element of the array (Yes at Step S203), the array processing unit 15c creates an array and adds an element (Step S204). Thereafter, the process at 5202 and the subsequent processes are executed. For example, if the read data is at the beginning of the array, the array processing unit 15c creates a new array in a database that is used by an application. If the read data is to be at the beginning of the second array, the array processing unit 15c creates a second array in the database used by an application. Furthermore, if the read data is an array element that has been created and that is to be at the beginning of the array, the array processing unit 15c creates a new array, as an element of the created array, in a database that is used by an application.

In contrast, if the determining unit 15a determines that the read data is not an element of the array (No at Step S203) but is an object (Yes at Step S205), the object processing unit 15d creates an object (Step S206). Then, the process at S202 and the subsequent processes are repeated. For example, if the read data is an object, the determining unit 15a creates an object for the database that is used by an application.

Furthermore, if the determining unit 15a determines that the read data is neither an element of an array (No at Step S203) nor an object (No Step S205), the determining unit 15a adds the data, which is to be converted, as the object or a value of the array (Step S207). For example, the determining unit 15a uses the value for the array or the element of the object that has been already created in the database used by an application.

Then, if an unprocessed element is present in the database to be decoded (Yes Step S208), the determining unit 15a returns to Step S201 and repeats the subsequent processes on the subsequent element. In contrast, if an unprocessed element is not present in the database to be decoded (No Step S208), the determining unit 15a ends the decoding process.

### Specific Example

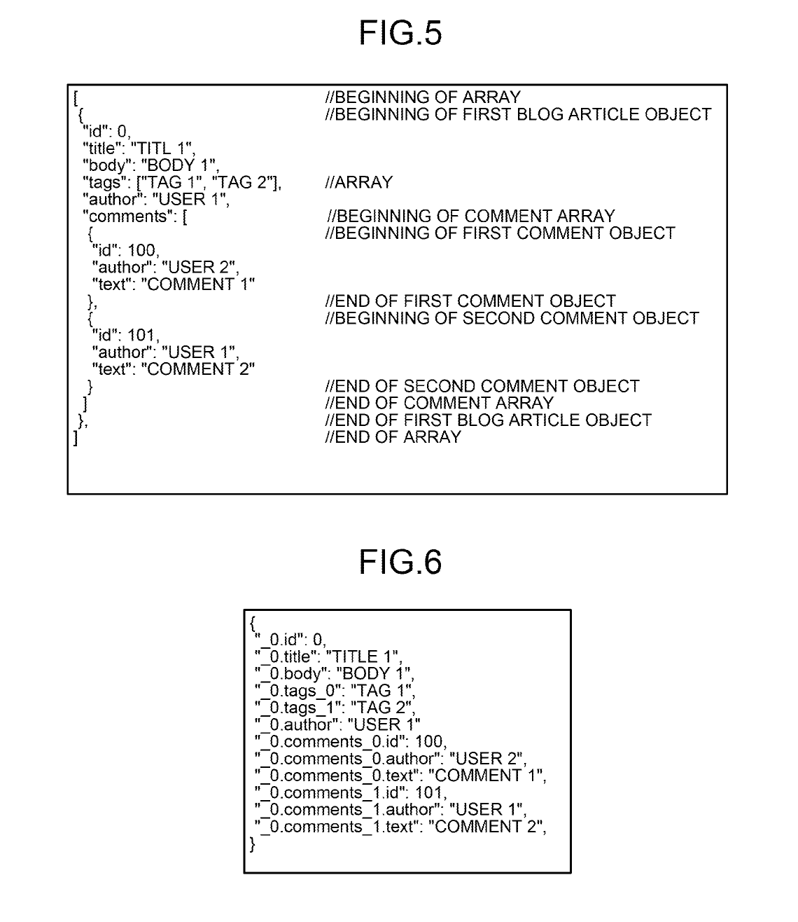

In the following, a specific example of the encoding process illustrated in FIG. 3 and the decoding process illustrated in FIG. 4 will be described with reference to FIGS. 5 and 6. FIG. 5 is a schematic diagram illustrating an example configuration of data to be processed on the application server side. FIG. 6 is a schematic diagram illustrating an example configuration of data stored in a database.

In the following, a description will be given of a case, as an example, in which data is sent and received in a JSON format; however the configuration is not limited thereto. For example, any format may also be uses as long as the data is structured. Furthermore, in practice, four or five hierarchical data models are usually used; however, for ease of description, a description will be given using a single hierarchical data model. Furthermore, a description will be given of a database, as an example, in which a comment or the like is added to a blog article.

Specific Example of Encoding

In the following, a description will be given of a specific example in which the data illustrated in FIG. 6 is created from the data illustrated in FIG. 5. First, the determining unit 14a reads “[”, which is at the top in the database illustrated in FIG. 5. Then, the determining unit 14a determines that the read “[” is the beginning of the array. Because the subject “[” is the beginning of the array, the array processing unit 14b creates “_{—}0” as “prefix+symbol+sequence number”.

Subsequently, the determining unit 14a reads “{“id”” from the database illustrated in FIG. 5, determines that the read data is an element of the array because “{” is present, and determines that ““id”” is an object. Specifically, the determining unit 14a determines that the read “{“id”” is a comment object.

Then, the object processing unit 14c creates “.id” or the like as “prefix+symbol+key”; however, because “_{—}0” is already added to the prefix, the object processing unit 14c creates ““_{—}0.id””.

Subsequently, the determining unit 14a reads “:0” from the database illustrated in FIG. 5. Because “:0” is neither an array nor an object, the determining unit 14a determines that “:0” is a value. Then, because ““0.id”” is already created, the object processing unit 14c creates ““_{—}0.id”:0” by associating ““0.id”” with “:0”. Specifically, the object processing unit 14c creates data in a KVS format in which ““_{—0}.id”” is a key and “:0” is a value.

Subsequently, the determining unit 14a reads “,” from the database illustrated in FIG. 5. Because the read data is information indicating the start of a new line, the determining unit 14a executes the same process described above on the data below.

As described above, the encoding processing unit 14 processes, as an array, between “[” and “]”, which indicate the array, and processes, as the same hierarchy, between “{” and “}”. Specifically, because the encoding processing unit 14 handles “id”, “title”, “body”, “tags”, “author”, and “comments” as the same hierarchy, the encoding processing unit 14 adds “_{—}0” as the prefix for all of the data mentioned here.

In the following, as another example, a description will be given of ““tags”:[“tag 1”, “tag 2”]” illustrated in FIG. 5. This data indicates that the value of the object “tags” is an array. Accordingly, the encoding processing unit 14 adds sequence numbers in order to distinguish “tag 1” from “tag 2”. Specifically, the encoding processing unit 14 identifies the “tag 1” as the 0^{th} data and the “tag 2” as the 1^{st} data. Consequently, the encoding processing unit 14 converts ““tags”:[“tag 1”, “tag 2”]” to ““_{—}0.tags_{—}0”:tag 1” and ““_{—}0.tags_{—}1”:tag 2”.

Furthermore, as another example of the same type of data as the above, a description will be given of ““comments”:[{˜},{˜}]”. This data indicates that the value of the object “comments” is an array. Furthermore, each element in this data is composed of multiple pieces of data. Specifically, the data contained in “{ }” is processed as the same hierarchy. Specifically, “id, author, text” of the first “{ }” is handled as the same hierarchy and each of “id, author, text” contained in the second “{ }” are handled as the same hierarchy. Furthermore, a sequence number is added to each element. Consequently, the encoding processing unit 14 processes the first “{˜}” as the 0^{th} array and the subsequent “{˜}” as the 1^{st} array.

Specifically, the encoding processing unit 14 converts ““comments”:[{” to ““_{—}0.comments_{—}0””. Then, the encoding processing unit 14 converts ““id”:100”, which is subsequent to ““comments”:[{”, to ““_{—}0.comments_{—}0.id:100””. Similarly, the encoding processing unit 14 converts ““author”:user 2”, which is subsequent to ““comments”:[{”, to ““_{—}0.comments_{—}0.author:user 2””. Similarly, the encoding processing unit 14 converts ““text”:comment 1”, which is subsequent to ““comments”:[{”, to ““_{—}0.comments_{—}0.text:comment 1””.

Furthermore, the encoding processing unit 14 converts “{”, which is subsequent to ““comments”:[{”, to ““_{—}0.comments_{—}1””. The encoding processing unit 14 converts ““id”:101”, which is subsequent to the second “{”, to ““_{—}0.comments_{—}1.id:101””. Similarly, the encoding processing unit 14 converts ““author”:user 1”, which is subsequent to the second “{”, to ““_{—}0.comments_{—}1.author:user 1””. Similarly, the encoding processing unit 14 converts ““text”:comment 2”, which is subsequent to the second “{”, to ““_{—}0.comments_{—}1.text:comment 2”. For the other data, the encoding processing unit 14 executes the same process as that described above; therefore, a description in detail will be omitted.

Specific Example of Decoding

In the following, a description will be given of a specific example in which the data illustrated in FIG. 5 is created from the data illustrated in FIG. 6. First, the determining unit 15a reads {“_{—}0.id”:0”, which is at the top in the database illustrated in FIG. 6. Subsequently, the key analyzing unit 15b deletes “ ”, which is at the top of the element ““_{—}0.id”:0”, and reads ““_{—}0.id”:0”, which is subsequent to the deleted “ ”.

Subsequently, the determining unit 15a extracts, from the read data ““_{—}0.id”:0”, “_{—}0” located between “″”, which indicates the beginning of the key, and “.”, which is the symbol indicating an object. Then, because “_” is the symbol indicating an array and “0” is a sequence number allocated to the array, the determining unit 15a determines that “_{—}0” is the beginning of an array. Then, because the extracted data is at the beginning of both the array and the database, the array processing unit 15c creates data “[” as the top of data in the database associated with an application. Furthermore, because an element of the array is subsequent to the created data “[”, the array processing unit 15c creates data “{” subsequent to the data “[”. At this point, “[{” is created.

Thereafter, the determining unit 15a extracts, from the read data ““_{—}0.id”:0”, “.id” located between the read element and “″”, which is the symbol indicating the end of the key. Then, because “.” is the symbol indicating an object and “id” is the object, the determining unit 15a determines that “.id” is an object. Then, the object processing unit 15d creates “id” as an object. At this point, if an array is created by the array processing unit 15c, the object processing unit 15d uses the object “id” as an element of the array. At this point, “[{“id”” is created.

Furthermore, if the subsequent element is “:0”, because “:0” contains neither a symbol indicating an array nor an object, the determining unit 15a determines that the subject data, i.e., “:0”, is a “value”. Specifically, the determining unit 15a determines that “:0” is a value of “id”. Consequently, “[{“id”:id” is created.

In the following, a description will be given of an example in which ““_{—}0.tags_{—}0”:“tag_{—}1”” is read as data to be processed. In this case, similarly to the process described above, for ““_{—}0.tags“ ”, the decoding processing unit 15 determines that “the 0^{th} object in the array is the tags”. Furthermore, because “_”, which indicates an array, and the sequence number “0”, which is allocated to the array, are present subsequent to the tags, the decoding processing unit 15 determines that “the tags, which is an object, contains the tag 1 as the 0^{th} element of the array”. Consequently, the decoding processing unit 15 converts ““_{—}0.tags_{—}0”:“tag 1”” to ““tags”:[“tag 1”]”.

Furthermore, as the data to be processed, ““_{—}0.tags_{—}1”:“tag 2”” is present subsequent to ““_{—}0.tags_{—}0”:“tag 1””. Similarly to the process described above, for ““_{—}0.tags””, the decoding processing unit 15 determines that “the 0^{th} object in the array is the tags”. Furthermore, because “_”, indicating an array, and the sequence number “1” allocated to the array are present subsequent to the tags, the decoding processing unit 15 determines that “the tags, which is an object contain a tag 2 as the first element of the array”. Consequently, when converting ““_{—}0.tags_{—}0”:“tag 2””, the decoding processing unit 15 adds an element to ““tags”:[“tag 1”]”, thus converting it to ““tags”:[“tag 1”, “tag 2”]”.

In the following, a description will be given of an example in which ““_{—}0.comments_{—}0.id”:100” is read as data to be processed. In such a case, similarly to the process described above, for ““_{—}0.comments””, the decoding processing unit 15 determines that “the 0^{th} object in the array is a comments”. Furthermore, the decoding processing unit 15 detects that “ ” indicating an array, the sequence number “0” allocated to the array, and “.id” indicating an object are present subsequent to the comments.

Accordingly, for the ““_{—}0.comments_{—}0.id””, the decoding processing unit 15 determines that “the comments, which is an object, has “id”, which is an object, as the 0^{th} element in the array”. Furthermore, because “:100” is subsequent to ““_{—}0.comments_{—}0.id””, the decoding processing unit 15 determines that the value of “id”, which is an object, is “100”. Consequently, the decoding processing unit 15 converts ““_{—}0.comments_{—}0.id”:100” to ““comments”:[{“id”:100”.

Furthermore, for ““_{—}0.comments_{—}0.author”:user 2”, the decoding processing unit 15 determines that “the comments, which is an object, has an “author”, which is an object, as the 0^{th} element in the array”. Furthermore, the decoding processing unit 15 determines that the value of the “author”, which is an object, is “user 2”. Accordingly, the decoding processing unit 15 converts ““_{—}0.comments_{—}0.author”:user 2” to ““comments”:[{“author”:user 2”. However, in the array that contains the comments, the data associated with “id” has already been converted. Accordingly, the decoding processing unit 15 converts ““_{—}0.comments_{—}0.author”:user 2” to ““author”:user 2”. For the other data, the decoding processing unit 15 executes the same process as that described above; therefore, a description in detail will be omitted.

### Advantages

As described above, when hierarchical structure data that is processed by an application is stored in a KVS that is to be processed by a database server, the converting unit 13 according to the first embodiment can convert data by changing the conversion rule depending on whether the data is an array or an object.

Furthermore, when converting a KVS to be processed by a database server to hierarchical structure data that is processed by an application server, the converting unit 13 according to the first embodiment can convert data by changing the conversion rule depending on whether the data is an array or an object. In this way, even if the data models to be processed differs between the application server and the database server, the converting unit 13 according to the first embodiment can automatically convert the data model.

Accordingly, an application can be developed without taking into consideration the data model to be processed by a database server. Consequently, the converting unit 13 according to the first embodiment makes an automatic data model conversion possible, thus improving the efficiency with which an application is developed.

### [b] Second Embodiment

In the first embodiment, a description has been given of a case in which a data model used by an application is converted to a data model used by a database server and vice versa; however, the embodiment is not limited thereto. For example, addition or deletion of data may also be executed. Accordingly, in a second embodiment, a description will be given of a case, as an example, in which data is added to a data model in a database server and data is deleted from the data model in a database server without the application taking into consideration a data model in the database server.

### Addition Example 1

### The End of Data

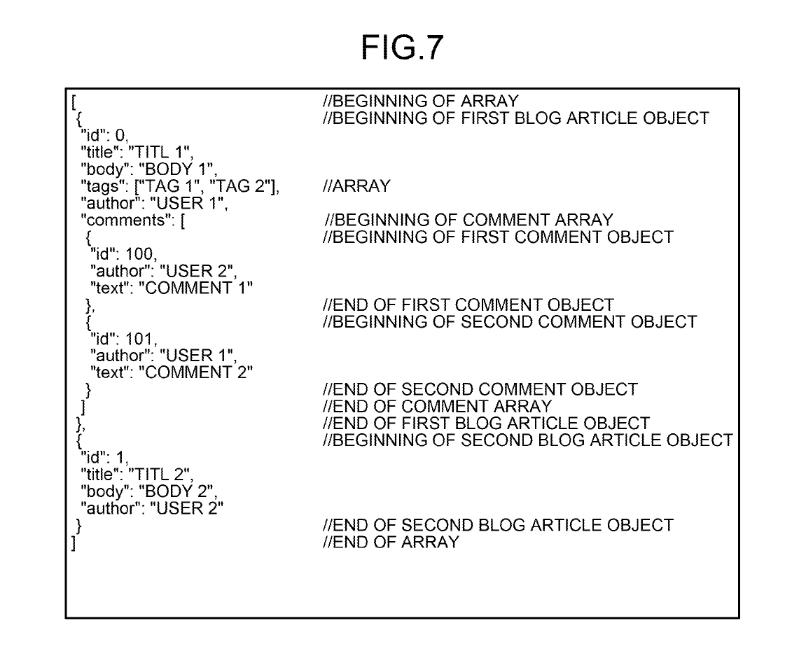

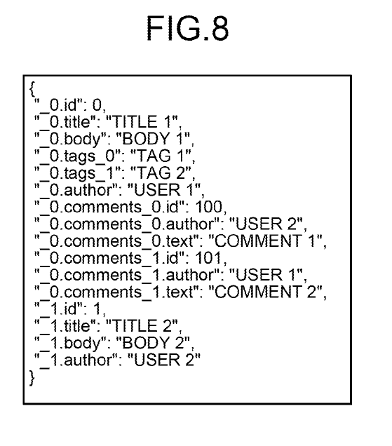

In the following, a description will be given of a case in which the data structure illustrated in FIG. 7 is created by adding data to the end of the data structure illustrated in FIG. 5. FIG. 7 is a schematic diagram illustrating an example configuration of data obtained by adding data to the main body of the data illustrated in FIG. 5. FIG. 8 is a schematic diagram illustrating an example configuration of data that is stored in a database after the main body is added. Specifically, in the following, a description will be given of a case in which the data structure illustrated in FIG. 8 is created by adding data, on the application side, such that the data structure illustrated in FIG. 7 is obtained and by adding data, on the database server side, in the state illustrated in FIG. 6.

For example, the application 11 executes, with respect to the addition processing unit 16, “append(<data content>);” as an application program interface (API). The following character string is then stored in the data content.

{

“id”:1,
“title”:“title 2”,
“body”:“body 2”,
“author”:“user 2”,

}

Specifically, because the top of the data item is “{”, the addition processing unit 16 recognizes that this is the beginning of an element in an array that is to be added. Then, the addition processing unit 16 searches the database illustrated in FIG. 6 for a character string that begins with “_”, which indicates an array, and that has the largest number subsequent to the “_”. More specifically, the addition processing unit 16 searches the data illustrated in FIG. 6 from the top and recognizes that the last line is ““_{—}0.comments_{—}1.text”:“comment 2”,”. Then, the addition processing unit 16 specifies that the number that begins with “_” and that has the largest number is “0”.

Then, the addition processing unit 16 allocates a number by incrementing the value of the specified number by 1. Specifically, in order to store each of the data items in the database, the addition processing unit 16 allocates “1”, as a subsequent array that is subsequent to the “0^{th}”, array that has already been stored.

Thereafter, in accordance with the conversion rule described in the first embodiment using the flowchart, the addition processing unit 16 creates an item name on the basis of the allocated number. Specifically, if the data to be stored is the item name of an object, the addition processing unit 16 creates “.” in “_{—}1” and a data item in which the item name is added. Furthermore, if the data to be stored is an array, the addition processing unit 16 creates, in “_{—}1”, a data item in which “_” is added. Furthermore, if the data to be stored is a value, the addition processing unit 16 creates a key+value as a value of the data item in which the value has already been created.

For example, in the case of ““id”:1,”, the addition processing unit 16 determines that “id” is an object and then creates “_{—}1.id” by adding both “.” and an item name to “_{—}1”. Subsequently, the addition processing unit 16 reads “:1,”, determines that this is a value, and uses it as the value of the data item “_{—}1.id”. Specifically, the addition processing unit 16 creates ““_{—}1.id”:1”.

By recursively and repeatedly performing the above process on each piece of data to be added, as illustrated in FIG. 8, data can be added as elements of a new array. Specifically, a second blog article can be added.

Data Reference

In the following, a description will be given of a case in which the application executed by the application server 10 refers to the data stored in the database server 40. For example, the application 11 executes, with respect to the converting unit 13, “getlist( )” as an API.

Subsequently, the converting unit 13 searches the database illustrated in FIG. 8 for a character string that begins with “_” and that has the largest number subsequent to the “_”. In the example illustrated in FIG. 8, the converting unit 13 detects “_{—}1.author”.

Then, the converting unit 13 acquires an item name that begins with “1.”. For each of the acquired items, the converting unit 13 converts it to an array if a number is added to “_” and converts it to an object if “.” is indicated. Consequently, the converting unit 13 then sends the following character string to the application as a reply.

{

“id”:1,
“title”:“title 2”,
“body”:“body 2”,
“author”:“user 2”,

}

### Addition Example 2

### Midpoint

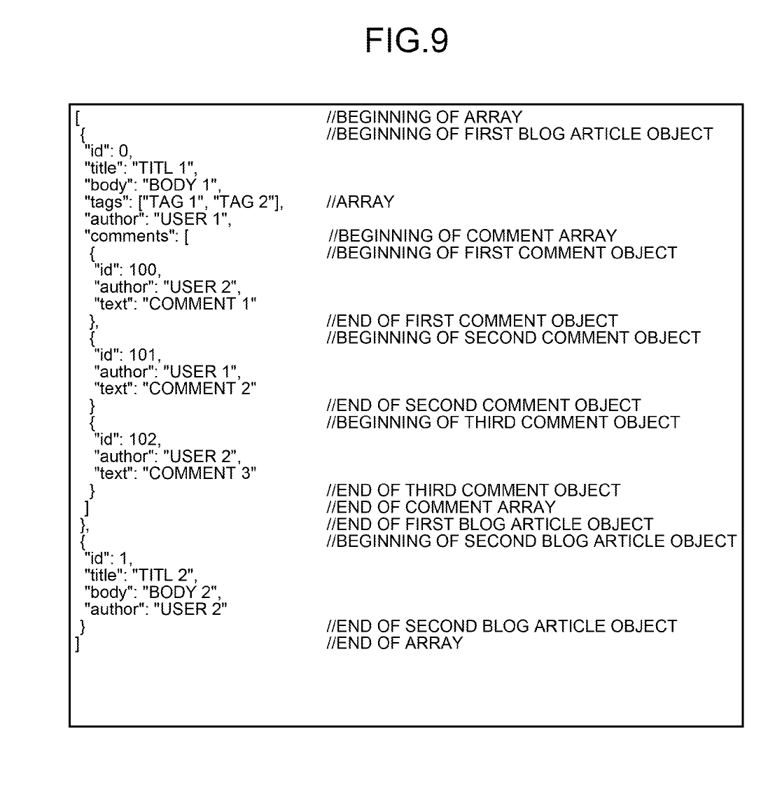

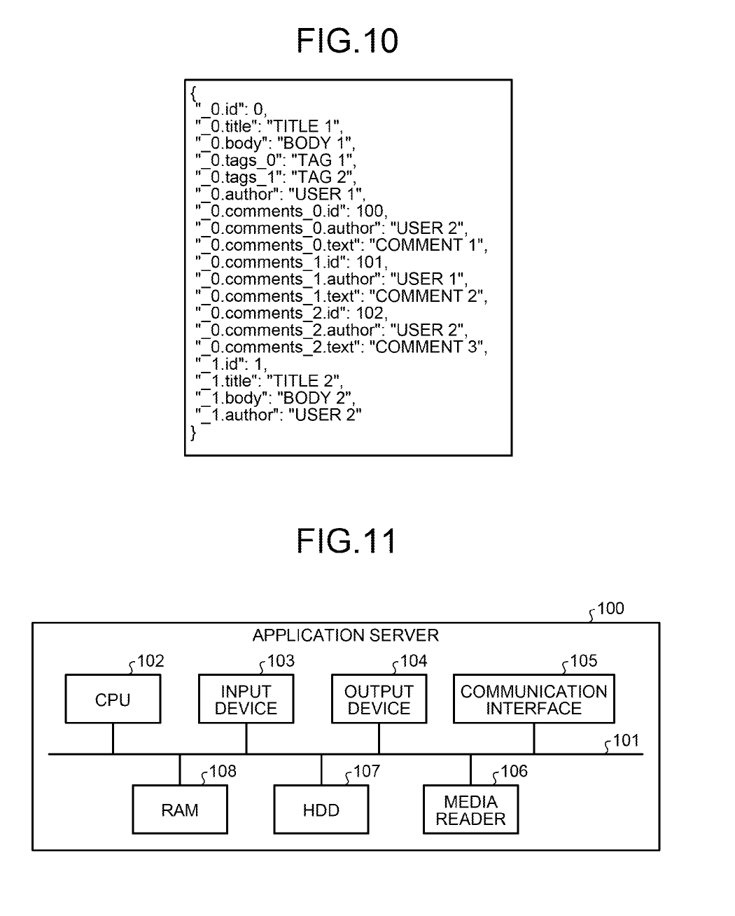

In the following, a description will be given of a case in which the data structure illustrated in FIG. 9 is created by adding data to a midpoint of the data structure illustrated in FIG. 7. FIG. 9 is a schematic diagram illustrating an example configuration of data obtained by adding a comment to the data illustrated in FIG. 7. FIG. 10 is a schematic diagram illustrating an example configuration of data stored in a database after a comment is added. Specifically, in the following, a description will be given of a case in which the data structure illustrated in FIG. 10 is created by adding data, on the application side, such that the data structure illustrated in FIG. 9 is obtained and by adding data, on the database server side, in the state illustrated in FIG. 8.

For example, the application 11 executes, with respect to the addition processing unit 16, “append(<addition target>,<data content>);” as an API. The data getFirst( ).comments is specified as data to be added and the following character string is stored in the data content.

{

“id”:102,
“author”:“user 2”,
“text”:“comment 3”,

}

Specifically, the addition processing unit 16 determines that the data to be added is a null character. Subsequently, for “getFirst( )”, which indicates the top element in an array, the addition processing unit 16 adds “_{—}0” to the data to be added. Specifically, the data to be added is “_{—}0”. Furthermore, if the data to be added is the item name of an object, the addition processing unit 16 creates a data item by adding “.” to the data to be added. Specifically, the data to be added is ““_{—}0.comments””.

Then, the addition processing unit 16 adds the data to the array. Specifically, the addition processing unit 16 searches the database illustrated in FIG. 8 for a character string that begins with “_” subsequent to the data to be added and that has the largest number subsequent to the “_”. Specifically, the addition processing unit 16 searches the data illustrated in FIG. 8 from the top and recognizes that the last line having the largest number subsequent to the ““_{—}0.comments””, which is to be added, is ““_{—}0.comments_{—}1.text”:“comment 2”,”. Then, the addition processing unit 16 specifies that the number that begins with “_” subsequent to the data to be added and that has the largest number subsequent thereto is “1”. Thereafter, the addition processing unit 16 allocates “2”, which is obtained by adding 1 to the obtained number “1”. Specifically, the data to be added is ““_{—}0.comments_{—}2””.

Thereafter, the addition processing unit 16 creates an item name on the basis of the allocated number. Specifically, if the data is the item name of an object, the addition processing unit 16 creates a data item in which “.” is added to “_{—}1”. Furthermore, if the data to be added is an array, the addition processing unit 16 adds a sequence number to data in which “_” is added to “_{—}1”. Furthermore, if the data to be added is a value, the addition processing unit 16 creates key+value as a value of the data item in which the value has already been created.

For example, in a case of ““id”:102,”, the addition processing unit 16 determines that “id” is an object and creates “_{—}0.comments_{—}2.id” by adding both “.” and an item name to “_{—}2”. Subsequently, the addition processing unit 16 reads “:102,”, determines that this is a value, and uses the value as the value of data item “_{—}0.comments_{—}2.id”. Specifically, the addition processing unit 16 creates ““_{—}0.comments_{—}2.id”:102”.

By recursively and repeatedly performing the above process on each piece of data to be added, as illustrated in FIG. 10, data can be added as an element of a new array of the comment that has already been stored. Specifically, a comment can be added to the first blog article.

### Deletion Example

In the following, a description will be given of an example in which data is deleted from the data structure illustrated in FIG. 10. An example in which deleting a second blog article is deleted will be described. Specifically, a description will be given of a case, as an example, in which data is deleted from a database server by an operation performed by an application without the application taking into consideration a data model in a database server.

The application 11 executes, with respect to the deletion processing unit 17, “delete(<data to be deleted>);” as an API. For the data to be deleted, getFirst( ) .next is specified.

The deletion processing unit 17 determines that the data to be deleted is a null character. Then, for “getFirst( )”, which indicates the top element in an array, the deletion processing unit 17 adds “_{—}0” to the data to be deleted indicating the top data. Then, the data to be deleted is “_{—}0”. Subsequently, for “next( )” representing the subsequent element in the array, the deletion processing unit 17 replaces the number subsequent to “_”, which is at the end of the data to be deleted with a number incremented by one. Specifically, the data to be deleted becomes “_{—}1”. Then, the deletion processing unit 17 deletes all of the data beginning with the data to be deleted. Specifically, the deletion processing unit 17 deletes all of the data that begins with “_{—}1”. Specifically, the following data is deleted.

{

“_1.id”:1,
“_1.title”:”title 2”,
“_1.body”:”body 2”,
“_1.author”:“user 2”,

}

By performing the process described above, even if data models are stored in different servers, an arbitrary data item can be deleted. Consequently, data can be freely added or deleted to/from a database regardless of the data model.

### [c] Third Embodiment

In the above explanation, a description has been given of the embodiments according to the present invention; however, the embodiments are not limited thereto and can be implemented with various kinds of embodiments other than the embodiments described above. Therefore, another embodiment will be described below.

Data Structure

The data structure described in the above embodiments is only an example and is not limited to the data structure described in the embodiments. For example, in the above embodiments, a description has been given of a single hierarchy as an example; however, two or more hierarchies may also be processed in a similar manner. Furthermore, in the embodiments described above, a description has been given of a case, as an example, in which data is received and sent in the JSON format; however, the configuration is not limited thereto. For example, another format, such as the extensible markup language (XML) format, may also be used.

Conversion Engine

In the embodiments described above, a description has been given of a case in which an application server includes a converting unit; however, the embodiment is not limited thereto. For example, a database server may also have a converting unit. Furthermore, it may also possible to use a server device that includes a converting unit that performs a data model conversion process, where the converting unit is arranged in a unit outside the application server and the database server.

Conversion Rule

In the embodiments described above, a description has been given, as an example, of a case in which data is integrated by using “_” for an array and using “.” for an object; however, the embodiment is not limited thereto. For example, another symbol, such as “#” or “$” may also be used. Furthermore, a description has been given of a case in which a number is incremented from 0 as order information; however, the embodiment is not limited thereto. For example, it is possible to decrement a number from 100, and an arbitrary method may also be used as long as the order can be specified.

System

Of the processes described in the embodiments, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. Furthermore, all or any part of the processing functions performed by each device can be implemented by a CPU and by programs analyzed and executed by the CPU or implemented as hardware by wired logic.

Hardware Configuration

The various processes described in the above embodiments can be implemented by programs prepared in advance and executed by a computer such as a personal computer or a workstation. Accordingly, in the following, an example of a computer system that executes a program having the same function performed by the apparatus in the above embodiments will be described.

FIG. 11 is a schematic diagram illustrating an example of the hardware configuration. As illustrated in FIG. 11, an application server 100 includes a CPU 102, an input device 103, an output device 104, a communication interface 105, a media reader 106, a hard disk drive (HDD) 107, and a random access memory (RAM) 108. Furthermore, each of the devices illustrated in FIG. 11 is connected to each other via a bus 101.

The input device 103 is a mouse or a keyboard; the output device 104 is, for example, a display; the communication interface 105 is an interface, such as a network interface card (NIC). The HDD 107 stores therein a program, data, and the like that execute function illustrated in, for example, FIG. 2. The HDD 107 is mentioned as an example of a recording medium; however, various programs may also be stored in another computer readable recording medium, such as a read only memory (ROM), a RAM, or a CD-ROM and may also be read by a computer. Furthermore, a program may also be obtained and used by arranging a storage medium at a remote site and by a computer accessing the storage medium. Furthermore, at this time, the obtained program may also be stored in the recording medium in the computer.

The CPU 102 reads the program that executes the same process as that performed by each processing unit illustrated in FIG. 2 and loads it in the RAM 108, and thus the program functions as a process that executes each function described with reference to, for example, FIG. 2. Specifically, the process executes the same function as that performed by the application 11, the database connecting unit 12, and the converting unit 13. In this way, by reading and executing the program, the application server 100 operates as an information processing apparatus that executes the data model conversion method.

Furthermore, the application server 100 reads the program from the recording medium and executes the read program, thereby implementing the same function described in the embodiments. Furthermore, the program mentioned in the embodiment is not limited to the program executed by the application server 100. For example, the present invention can also be used in a case in which another computer or a server executes the program or executes the program in a cooperative manner.

It is possible to improve the efficiency with which an application is developed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention have been described in detail, it should be understood that the various changes, substitutions, and alterations could be made hereto without departing from the spirit and scope of the invention.

What is claimed is:

1. A computer-readable recording medium having stored therein a program causing a computer to execute a data model conversion process comprising:
determining the type of a data item of which data that is defined in a first data model is composed;
adding, when it is determined at the determining that the type of the data item is an array, information obtained by binding array information indicating an array with order information indicating the order of an array to an item name of data that is defined in a second data model by using the item name and a value;
adding, to the item name when it is determined at the determining that the type of the data item is an object, information obtained by binding object information indicating an object with an element; and
creating, when it is determined at the determining that the type of the data item is a value, data that is defined in the second data model by associating the value with the item name.

2. The computer-readable recording medium according to claim 1, wherein the data model conversion process further comprises:
creating, when data to be added to a database that is defined in the second data model is a new array, the item name by binding the array information with order information specifying data at the end of the database,
adding, to the item name, information obtained by binding the object information with an element that is an object in the data to be added, and
adding, as the new array to the database that is defined in the second data model, data in which a value of the data to be added is associated with the item name.

3. The computer-readable recording medium according to claim 1, wherein the data model conversion process further comprises:
adding, when data to be added to a database that is defined in the second data model is a new element in an existing array, to an item name that specifies the existing array, information obtained by binding the array information with order information specifying an element at the end of the existing array, and
adding, to the item name, information obtained by binding the object information with an element that is an object in the data to be added, and
adding, as the new element in the existing array to the database that is defined in the second data model, data in which a value of the data to be added is associated with the item name.

4. The computer-readable recording medium according to claim 1, wherein the data model conversion process further comprises:
specifying, from a database when data to be deleted from the database that is defined in the second data model is an array, data that has, as the item name, a combination of the array information specifying the array and the order information, and
deleting, from the database, data that has the combination of the specified array information and the order information.

5. A data model conversion method causing a computer to execute a process comprising:
determining the type of a data item of which data that is defined in a first data model is composed;
adding, when it is determined at the determining that the type of the data item is an array, information obtained by binding array information indicating an array with order information indicating the order of an array to an item name of data that is defined in a second data model by using the item name and a value;
adding, to the item name when it is determined at the determining that the type of the data item is an object, information obtained by binding object information indicating an object with an element; and
creating, when it is determined at the determining that the type of the data item is a value, data that is defined in the second data model by associating the value with the item name.

6. A data model conversion apparatus comprising:
a determining unit that determines the type of a data item of which data that is defined in a first data model is composed;
a first adding unit that adds, when the determining unit determines that the type of the data item is an array, information obtained by binding array information indicating an array with order information indicating the order of an array to an item name of data that is defined in a second data model by using the item name and a value;
a second adding unit that adds, to the item name when the determining unit determines that the type of the data item is an object, information obtained by binding object information indicating an object with an element; and
a creating unit that creates, when the determining unit determines that the type of the data item is a value, data that is defined in the second data model by associating the value with the item name created by the first adding unit or the second adding unit.
